(19) United States
(12) Patent Application Publication
(10) Pub. No.: US 2015/0066757 A1
(43) Pub. Date: Mar. 5, 2015

(54) METHOD AND SYSTEM FOR INSTANT DELIVERY OF VIRTUAL GIFT CARD ON MOBILE PLATFORM

(71) Applicant: MasterCard International Incorporated, Purchase, NY (US)

(72) Inventors: Kiran SHENOY, O'Fallon, MO (US); Gopinatha Joshi, Chesterfield, MO (US); Anupama Zagabathuni, Chesterfied, MO (US); Mandeep Sandhu, O'Fallon, MO (US); Haritha Nannapaneni, Chesterfield, MO (US)

(73) Assignee: MasterCard International Incorporated, Purchase, NY (US)

(21) Appl. No.: 14/017,659

(22) Filed: Sep. 4, 2013

(51) Int. Cl. G06Q 20/34; G06Q 20/40; G06Q 20/28

(52) U.S. Cl. CPC G06Q 20/342; G06Q 20/28; G06Q 20/40
USPC 705/41

(57) ABSTRACT

A method for processing a gift card request includes: receiving, by a receiving device, a gift card request, wherein the gift card request includes at least a merchant identifier, a gift amount, a payment account identifier, and a recipient; processing, by a processing device, a payment transaction for the gift amount from a payment account associated with the payment account identifier to a merchant account associated with the merchant identifier; identifying, by the processing device, a gift card number; associating, in a database, the identified gift card number with the merchant identifier and the gift amount such that payment transactions involving the identified gift card number are charged to the merchant account; and transmitting, by a transmitting device, the identified gift card number to the recipient.

### FIELD

The present disclosure relates to a technical solution to processing a request for a virtual gift card, specifically leveraging a virtual gift card, from a requester to a recipient, on a merchant account corresponding to the merchant for redemption of the virtual gift card.

### BACKGROUND

Gift cards are staple gifts that one person may give to another in a variety of situations. Gift cards can be useful if the giver is not sure what gift the receiver may want, if there are shipping or other transportation constraints for a gift, as a prize in a contest, as a topical vacation, etc. However, traditional physical gift cards still suffer from many of the constraints as traditional gifts. For example, procuring the gift card may necessitate a visit to the merchant or a wait on shipping of the card. As a result, some merchants have begun to enable gift givers to send recipients a virtual gift card.

Virtual gift cards typically are numbers that are generated by a merchant and then distributed to the recipient. The recipient may then use the number during a transaction, which is processed by the merchant prior to the transaction, and then the transaction processed traditionally for the remaining amount. However, virtual gift cards issued and processed by merchants are often closed loop systems operated by the merchants themselves, which require significant resources and expenses. As a result, small businesses are often unable to use such systems, and are thus unable to issue physical or virtual gift cards.

Some methods and systems have been developed to enable small businesses and other entities that lack closed loop gift card systems to issue gift cards to consumers, such as the in Control® platform by MasterCard®. Such platforms utilize controlled payment numbers that are limited to a particular merchant to operate as gift cards, as described in more detail in U.S. patent Ser. No. 13/791,122, entitled “Method and System for Creating and Processing Personalized Gift Cards,” filed Mar. 8, 2013, which is herein incorporated by reference in its entirety. However, controlled payment numbers are typically issued on the account of the requester. As a result, the virtual gift card could be revoked or adjusted at any time by the requester, the requester may view the receiver's use of the virtual gift card, and the merchant cannot appreciate the revenue from the virtual gift card until after its use.

Thus, there is a need for a technical solution to provide virtual gift cards that do not operate on merchant closed loop systems that are leveraged on a merchant account rather than the account of the requester.

### SUMMARY

The present disclosure provides a description of a system and method for the processing of a gift card request.

A method for processing a gift card request includes: receiving, by a receiving device, a gift card request, wherein the gift card request includes at least a merchant identifier, a gift amount, a payment account identifier, and a recipient; processing, by a processing device, a payment transaction for the gift amount from a payment account associated with the payment account identifier to a merchant account associated with the merchant identifier; identifying, by the processing device, a gift card number; associating, in a database, the identified gift card number with the merchant identifier and the gift amount such that payment transactions involving the identified gift card number are charged to the merchant account; and transmitting, by a transmitting device, the identified gift card number to the recipient.

A system for processing a gift card request includes a database, a receiving device, a processing device, and a transmitting device. The receiving device is configured to receive a gift card request, wherein the gift card request includes at least a merchant identifier, a gift amount, a payment account identifier, and a recipient. The processing device is configured to: process a payment transaction for the gift amount from a payment account associated with the payment account identifier to a merchant account associated with the merchant identifier; identify a gift card number; and associate, in the database, the identified gift card number with the merchant identifier and the gift amount such that payment transactions involving the identified gift card number are charged to the merchant account. The transmitting device is configured to transmit the identified gift card number to the recipient.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for the processing of virtual gift card requests in accordance with exemplary embodiments.

FIG. 2 is a block diagram illustrating the processing server of FIG. 1 for the processing of gift card requests in accordance with exemplary embodiments.

FIG. 3 is a flow diagram illustrating a method for processing of a request for a virtual gift card in accordance with exemplary embodiments.

FIG. 4 is a flow diagram illustrating a method for processing a payment transaction using a gift card issued using the system of FIG. 1 in accordance with exemplary embodiments.

FIG. 5 is a diagram illustrating a graphical user interface for requesting a virtual gift card in accordance with exemplary embodiments.

FIG. 6 is a diagram illustrating a graphical user interface for receiving and using a gifted virtual gift card in accordance with exemplary embodiments.

FIG. 7 is a flow chart illustrating an exemplary method for processing a gift card request in accordance with exemplary embodiments.

FIG. 8 is a block diagram illustrating computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

Controlled Payment Number—Controlled payment numbers may be payment numbers associated with a payment account that are subject to one or more rules. In many cases, these rules may be set by a cardholder, such as spending limits, limits on days and/or times of a transaction, limits on merchants or industries, transaction spending or frequency limits, etc. Controlled payment numbers may offer an account holder an opportunity to give payment cards tied to the account to others for use, but subject to rules set by the cardholder, such as an employer distributing cards to employees, or a parent distributing cards to children. Additional detail regarding controlled payment numbers may be found in U.S. Pat. No. 6,636,833, issued Oct. 21, 2003; U.S. Pat. No. 7,136,835, issued Nov. 14, 2006; U.S. Pat. No. 7,571,142, issued Aug. 4, 2009; U.S. Pat. No. 7,567,934, issued Jul. 28, 2009; U.S. Pat. No. 7,593,896, issued Sep. 22, 2009; U.S. patent application Ser. No. 12/219,952, filed Jul. 30, 2008; U.S. patent application Ser. No. 12/268,063, filed Nov. 10, 2008; and U.S. patent application Ser. No. 12/359,971, filed Jan. 26, 2009; each of which are herein incorporated by reference in their entirety.

### System for Processing Virtual Gift Card Requests

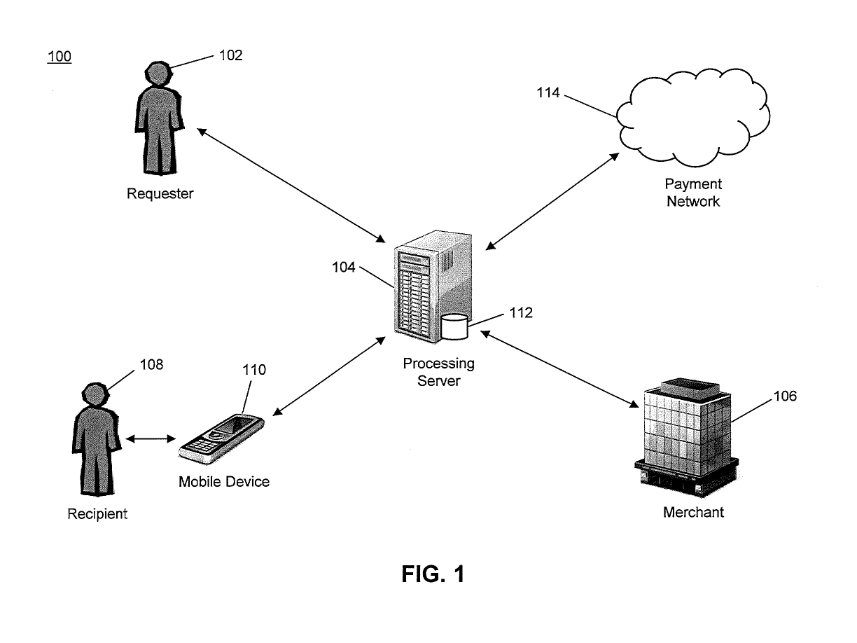

FIG. 1 illustrates a system 100 for processing virtual gift card requests for virtual gift cards leveraged on a merchant account.

A requester 102 may submit a request for a virtual gift card to a processing server 104. The request may be submitted via any suitable method, such as via an application program on a mobile communication device, a web page, kiosk, bank teller, ATM, etc. The request for a virtual gift card may include a gift amount representing the value of the virtual gift card and an account identifier for a payment account used to fund the purchase of the virtual gift card, and may also indicate a merchant 106 with whom the gift card may be redeemed, and a recipient 108 that is to receive the gift card.

The processing server 104 may receive the gift card request, and may process a payment transaction for the purchase of a corresponding virtual gift card, funded by the payment account indicated in the request. In some embodiments, the processing server 104 itself may process the payment transaction. In other embodiments, the processing server 104 may submit an authorization request for the payment transaction to a payment network 114 for processing.

Once the transaction has been processed, the processing server 104 may identify a gift card number to be used for the virtual gift card. Systems and methods for identifying and/or generating a gift card number will be apparent to persons having skill in the relevant art. The processing server 104 may also associate the identified gift card number with a payment account associated with the merchant 106, such that when the gift card is used by the recipient, the transaction will be funded by the merchant payment account. The processing server 104 may store the association information in a gift card database 112, discussed in more detail below.

The processing server 104, also discussed in more detail below, may then transmit the identified gift card number to the recipient 108. In one embodiment, the processing server 104 may transmit the identified gift card number to a mobile communication device 110 associated with the recipient 108. The recipient 108 may then use the mobile device 110 to present the virtual gift card to the merchant 106 to use the gift card in either an Internet-based transaction or an in-person transaction, depending of the product offering and the recipient or merchants desires.

The association of the gift card with the merchant payment account rather than with a payment account belonging to the requester 102 may enable the recipient 108 to freely use the gift card without intervention by the requester 102, or the requester necessarily having knowledge of the transaction (though a “thank you” alert to the requester 102 may be an additional feature, perhaps in the form or an option to the recipient 108. In addition, the managing of the gift card by the processing server 104 may enable small business merchants 106 to issue and process gift cards via the processing server 104 without the need to modify existing payment systems.

The system 100 for processing gift card requests for virtual gift cards may be advantageous over traditional systems for using virtual gift cards as it may provide more freedom to both recipients 108 and merchants 106, particularly small business merchants. However, the system 100 may also be configured to provide additional benefits to requesters 102. For example, the requester 102 may provide special messages, images, etc. to be distributed to the recipient 108 with the received gift card, or may set specific schedule for distribution of the gift card (e.g., on a special occasion, such as the recipient's 108 birthday).

In some embodiments, the processing server 104 may also require activation by the recipient 108 prior to use of a received gift card for additional security, such as to prohibit theft of the gift card or to mitigate an error in the distribution information provided by the requester 102. Methods for activating a received gift card will be apparent to persons having skill in the relevant art.

Processing Device

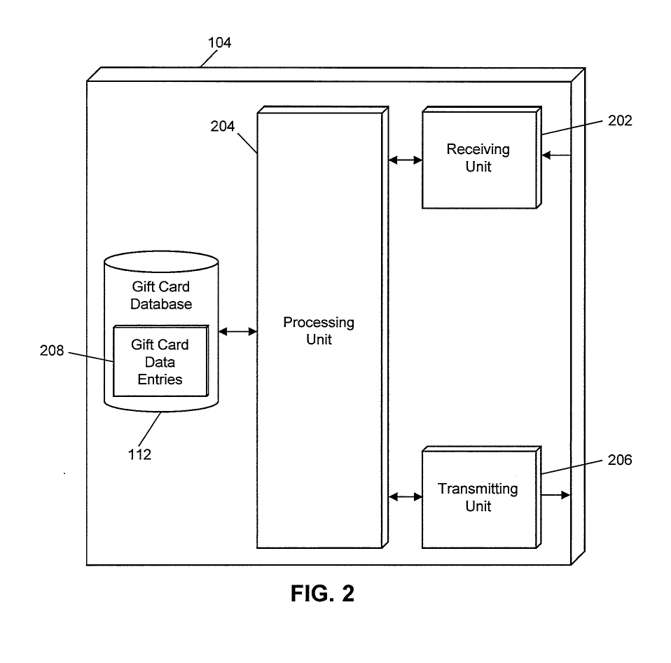

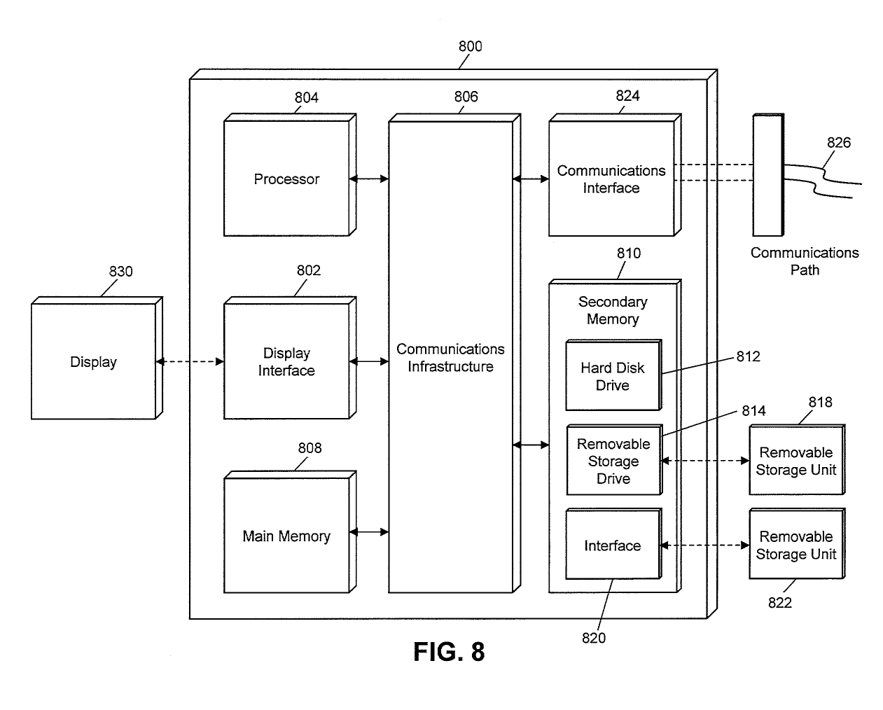

FIG. 2 illustrates an embodiment of the processing server 104 of the system 100. It will be apparent to persons having skill in the relevant art that the embodiment of the processing server 104 illustrated in FIG. 2 is provided as illustration only and may not be exhaustive to all possible configurations of the processing server 104 suitable for performing the functions as discussed herein. For example, the computer system 800 illustrated in FIG. 8 and discussed in more detail below may be a suitable configuration of the processing server 104.

The processing server 102 may include a receiving unit 202. The receiving unit 202 may be configured to interface (e.g., connect, communicate, etc.) with one or more networks in order to receive data, information, etc. via one or more network protocols, such as communicating with the Internet via an Internet Protocol (IP). The receiving unit 202 may be configured to receive a gift card request from the requester 102. The gift card request may include at least a merchant identifier, a gift amount, a payment account identifier, and a recipient identifier (e.g., the recipient 108).

The merchant identifier may be a unique value associated with the merchant 106 with whom the requested gift card is to be redeemed. The merchant identifier may be a number, such as a merchant identification number (MID), a merchant payment account number or identifier, merchant name, trade name, point-of-sale identifier, geographic location, or any other suitable value as will be apparent to persons having skill in the relevant art. In some embodiments, the merchant identifier may correspond to a plurality of merchants with whom the requested gift card may be redeemed.

The payment account identifier may be a unique value associated with a payment account (e.g., that may be associated with the requester 102) that is to be used to fund the purchase of the requested gift card. The payment account identifier may be an account number, a controlled payment number, a loyalty number, a gift card number, a name (e.g., of the account holder of the associated payment account), or any other suitable value as will be apparent to persons having skill in the relevant art.

The recipient 108 may be indicated in the gift card request by an identifier associated with the recipient 108 or a method of receiving the requested gift card. For example, the gift card request may include a username, name, e-mail address, phone number, an account number, or a consumer identifier. Additional methods for identifying the recipient 108 in a gift card request will be apparent to persons having skill in the relevant art. In one embodiment, the requester 102 may indicate themselves as the recipient of the gift card, which they may then provide to the recipient 108 for use at the merchant 106.

The processing server 104 may also include a processing unit 204. The processing unit 204 may be configured to initiate a payment transaction for the purchase of the requested gift card. In one embodiment, the processing unit 204 may be configured to process the payment transaction using systems and methods that will be apparent to persons having skill in the relevant art. In another embodiment, the processing unit 204 may be configured to generate an authorization request for the payment transaction for the gift amount and including the payment account identifier to be used to fund the transaction. The processing server 104 may include a transmitting unit 206, which may be configured to transmit the generated authorization request to the payment network 114 for processing. The receiving unit 202 may then receive an authorization response indicating approval or denial of the purchase of the gift card.

If the purchase of the gift card is successful, the processing unit 204 may identify a gift card number to be associated with the requested gift card. In some instances, identifying a gift card number may include requesting (e.g., via the transmitting unit 206) the gift card number from another entity (e.g., the payment network 114) and receiving (e.g., via the receiving unit 202) the gift card number. Once the number is identified, the processing unit 204 may store the gift card number in a gift card data entry 208 in the gift card database 110.

The gift card database 110 may be configured to store a plurality of gift card data entries 208. Each gift card data entry 208 may include data related to an issued virtual gift card, including an association of the gift card number associated with the related gift card and a merchant payment account associated with the merchant 106 as indicated in the gift card request. In some embodiments, the processing unit 204 may be also configured to place and/or request a hold on the merchant payment account for the gift amount. Each gift card data entry 208 may also include additional information that will be apparent to persons having skill in the relevant art, such as the gift amount, a remaining amount, an expiration date, the recipient 108, a personalized message, etc.

The transmitting unit 206 may also be configured to transmit at least the identified gift card number to the recipient 108. In some embodiments, the transmitting unit 206 may transmit the gift card number to the recipient 108 via a mobile device 110, such as via short message service (SMS) message. Methods suitable for the distribution of a gift card number to a recipient 108 will be apparent to persons having skill in the relevant art.

### Method for Processing a Virtual Gift Card Request

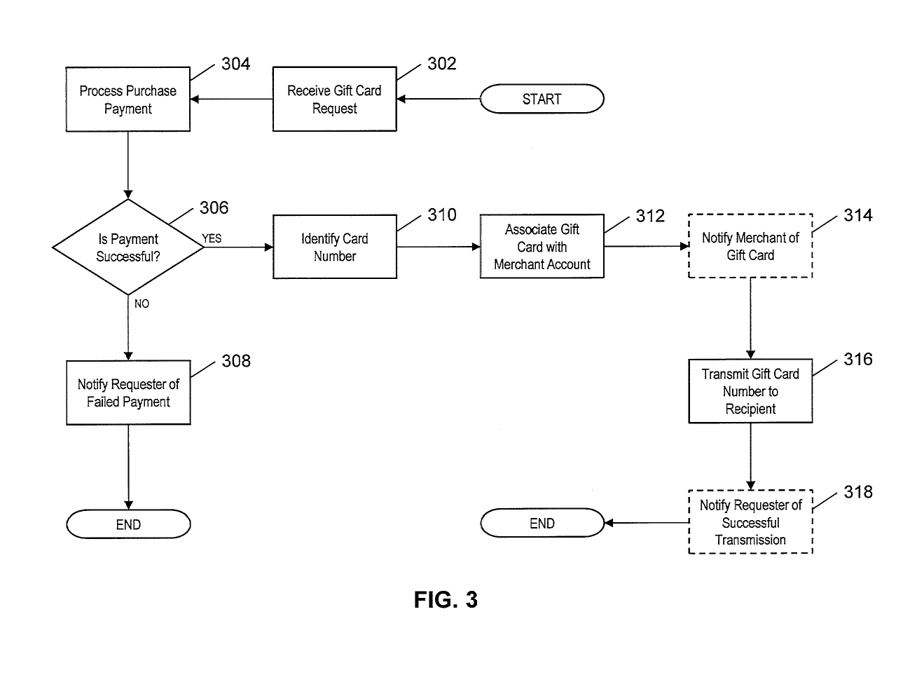

FIG. 3 illustrates a method for the processing of a virtual gift card request using the processing server 104 illustrated in FIG. 2.

In step 302, the processing server 104 may receive (e.g., via the receiving unit 202) a gift card request from the requester 102. The gift card request may include a merchant identifier associated with the merchant 106, a gift amount, a payment account identifier, and an identifier associated with the recipient 108. In step 304, the processing server 104 may (e.g., using the payment network 114) process a payment transaction for the purchase of the requested gift card using a payment account associated with the payment account identifier.

In step 306, the processing unit 204 of the processing server 104 may identify if the payment to purchase the gift card was successful. If the payment was unsuccessful (e.g., an authorization response denying the transaction was received) then, in step 308, the transmitting unit 206 may transmit a notification to the requester 102 indicating that the payment failed and the purchase of the gift card was unsuccessful. Alternatively, if the payment was successful, then, in step 310, the processing server 104 may identify a gift card number to be associated with the requested gift card.

In step 312, the processing server 104 may associate the identified gift card number with a merchant payment account associated with the merchant 106, such as by storing the association as a gift card data entry 208 in the gift card database 112. In some embodiments, the method may include step 314, where the transmitting unit 206 may transmit a notification to the merchant 106 indicating the purchase of the gift card by the requester 102. It will be apparent to persons having skill in the relevant art that step 314 may be an optional step.

In step 316, the transmitting unit 206 of the processing server 104 may transmit the gift card number to the recipient 108, such as by using the information included in the gift card request. In optional step 318, the transmitting unit 206 may also transmit a notification to the requester 102 indicating successful transmission of the gift card number to the recipient 108.

### Method for Processing a Virtual Gift Card Transaction

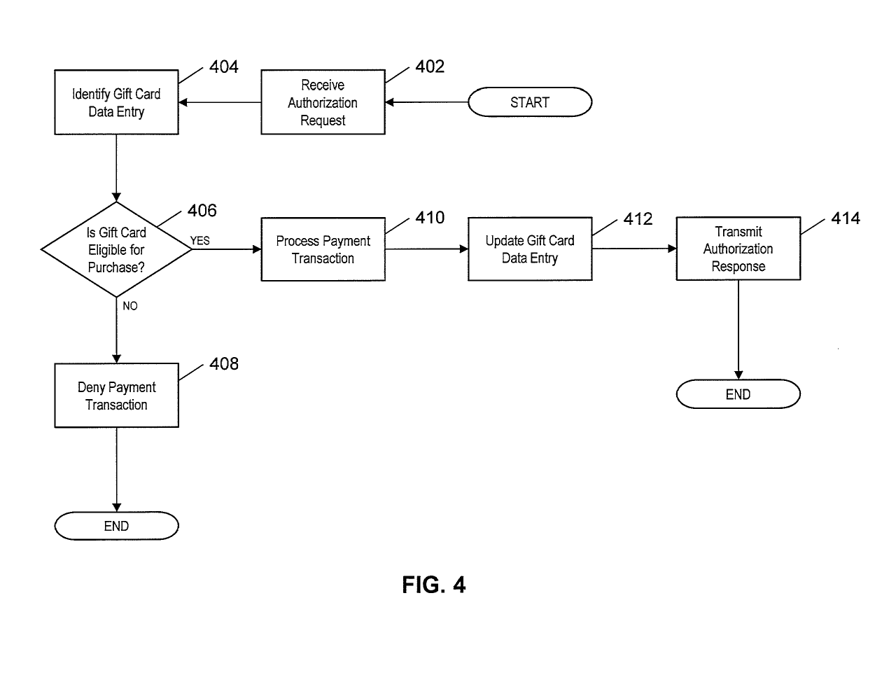

FIG. 4 illustrates a method for processing a payment transaction funded by the virtual gift card processed in the method illustrated in FIG. 3.

In step 402, the processing server may receive (e.g., via the receiving unit 202) an authorization request for a payment transaction, wherein the authorization request includes at least a gift card number, a merchant identifier, and a transaction amount. In step 404, the processing unit 204 of the processing server 104 may identify a gift card data entry 208 in the gift card database 112 that includes the gift card number included in the authorization request.

In step 406, the processing unit 204 may determine if the gift card is eligible to be used for the requested payment transaction. The gift card may be eligible if, for example, the merchant identifier included in the authorization request is included in the identified gift card data entry 208 and the gift card data entry 208 indicates a remaining balance on the related gift card. Systems and methods for determining the eligibility of a gift card for use in a transaction will be apparent to persons having skill in the relevant art. In some embodiments, the eligibility of the gift card may be based on additional limits set by the recipient 108, the requester 102, the merchant 106, the payment network 114, or other party, using the controlled payment number functionality.

If the gift card is determined to be ineligible for use in the requested transaction, then, in step 408, the transmitting unit 206 may transmit an authorization response to the authorization request indicating denial of the payment transaction. If, alternatively, the gift card is eligible for use, then, in step 410, the processing server 104 may process the payment transaction. The payment transaction may be funded by the merchant payment account based on the account identifier included in the identified gift card data entry 208. Methods and systems for processing a payment transaction will be apparent to persons having skill in the relevant art.

In step 412, the processing unit 204 may update the gift card data entry 208, such as by adjusting the amount remaining on the gift card based on the transaction amount for the payment transaction. In step 414, the transmitting unit 206 may transmit an authorization response indicating approval of the payment transaction. It will be apparent to persons having skill in the relevant art that step 414 may be performed prior or concurrently with step 412.

It should be noted that in certain embodiments, the recipient 108 can receive the cash value of the gift card at a merchant point of sale or an ATM. This can be an attractive feature for those consumers concerned about the full value of the card not being used, or concern that the recipient 108 may not desire to shop at the selected merchant. The merchant 106 (and any intermediaries that facilitate the gift card's distribution and use) would still benefit from transaction fees, advertising, holding the funds, etc.

### Graphical User Interface

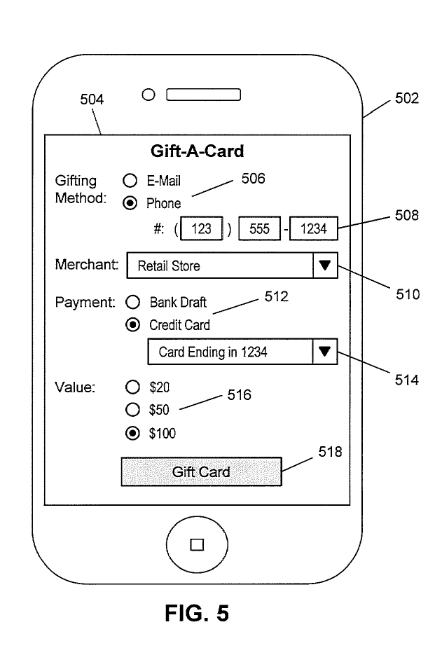

FIG. 5 illustrates a graphical user interface for the requesting of a virtual gift card using the system 100 of FIG. 1.

A mobile device 502 may include a display screen 504 configured to display a gift card request screen to the requester 102. Although the interface of FIG. 5 is illustrated as being displayed via an application program on a mobile device 502, it will be apparent to persons having skill in the relevant art that the gift card request screen may be accessed by the requester 102 via multiple methods and systems, such as via a web page by a computing device or a mobile device.

The display screen 504 may include a method selector 506. The method selector 506 may list a plurality of methods for the distribution of the requested gift card to the recipient 108. As illustrated in FIG. 5, the method selector 506 may include distribution via e-mail or phone, but may also include additional methods that will be apparent to persons having skill in the relevant art. Once the requester 102 has selected the method of distribution via the method selector 506, an additional field may be displayed to receive more information, such as the phone number field 508. The requester 102 may input the phone number of the intended recipient 108 in the phone number field 508.

The display screen 504 may also include a merchant selector 510. The merchant selector 510 may include a drop down menu or other suitable type of selector for selecting the merchant 106 with whom the requested gift card may be redeemed. The display screen 504 may further include a payment selector 512. The payment selector 512 may display multiple methods of payment to be selected by the requester 102 for use in funding a payment transaction for the purchase of the requested gift card.

Similar to the method selector 506, once the requester 102 has selected a payment method via the payment selector 512, the display screen 504 may also include a payment field 514. The payment field 514 may be a field where the requester 102 can enter the necessary information in order to use the payment method selected via the payment selector 512. Although it is illustrated in FIG. 5 as including a drop-down menu of saved payment card information, it will be apparent to persons having skill in the relevant art that the payment field 514 may consist of multiple fields, menus, etc. suitable for inputting necessary information.

The display screen 504 may also include a gift amount selector 516. The gift amount selector 516 may enable the requester 102 to select the value of the requested gift card. The gift amount selector 516 may include a list of predefined gift amounts, such as illustrated in FIG. 5, a field where a gift amount may be entered, a drop-down menu of predefined gift amounts, or any other suitable method of selection that will be apparent to persons having skill in the relevant art.

The display screen 504 may further include a submit button 518. The submit button 518 may, when interacted with by the requester 102, submit a gift card request to the processing server 104 including the information as indicated by the requester 102 via the display screen 504. In some embodiments, the display screen 504 may be configured to display a notification to the requester 102 (e.g., received from the processing server 104 following processing of the gift card purchase) indicating the successful or unsuccessful purchase of the gift card.

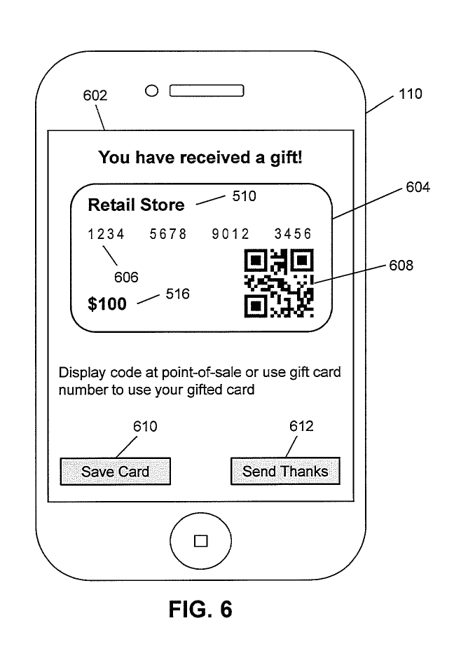

FIG. 6 illustrates a user interface of the mobile device 110 for display to the recipient 108, indicating the receipt of the gift card requested by the requester 102. The mobile device 110 may include a display screen 602, which, in some embodiments, may also be an input device, such as a capacitive touch display.

The display screen 602 may display a received gift card 604 to the recipient 108. In some embodiments, the display may be via an application program executed by the mobile device 110. In other embodiments, the display may be via a web page, such as one accessed via a web browsing application. The received gift card 604 may include the merchant 510 as selected via the merchant selector 510 on the display screen 504. The received gift card 604 may also display a gift card number 606 identified and associated with the received gift card 604, and the gift amount 516 previously selected by the requester 102.

The received gift card 604 may also include a machine-readable code 608. The machine-readable code 608 may be encoded with payment credentials including the gift card number 606. The merchant 106 may read, via a reading device, the machine-readable code 608 in order to receive the payment credentials for processing a payment transaction using the gift card 604. The machine-readable code 608 may be any suitable type of code capable of being encoded with payment credentials, such as a QR code as illustrated in FIG. 6.

The display screen 602 may include a save card button 610, which may save the payment details (e.g., the gift card number 606 and/or the machine-readable code 608) on the mobile device 110 for later use in funding a payment transaction. The display screen 602 may also include a send thanks button 612. The send thanks button 612 may enable the recipient 108 to enter a message or to select a predefined message to be transmitted to the requester 102 to thank the requester 102 for the gift.

### Exemplary Method for Processing a Gift Card Request

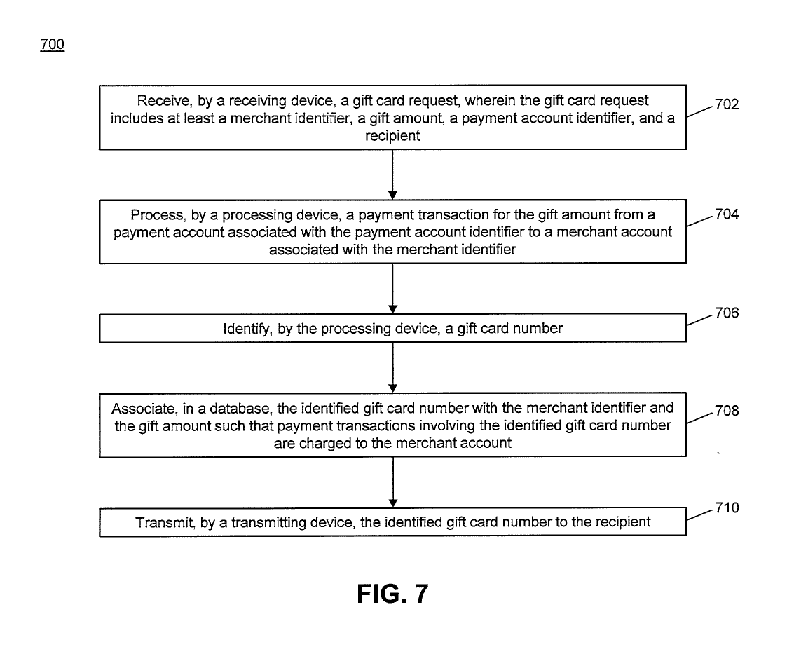

FIG. 7 illustrates a method 700 for processing a virtual gift card request.

In step 702, a gift card request may be received, by a receiving device (e.g., the receiving unit 202), wherein the gift card request includes at least a merchant identifier, a gift amount, a payment account identifier, and a recipient (e.g., the recipient 108). In some embodiments, the recipient 108 may be at least one of: a phone number, an e-mail address, an account number, a username, and a consumer identifier. In one embodiment, the gift card request may originate from a web page associated with the included merchant identifier.

In step 704, a processing device (e.g., the processing unit 204) my process a payment transaction for the gift amount from a payment account associated with the payment account identifier to a merchant account associated with the merchant identifier. In some embodiments, processing the payment transaction may include transmitting an authorization request to a payment network (e.g., the payment network 114) for the payment transaction and receiving, by the receiving device 202, an authorization response indicating approval of the payment transaction.

In step 706, the processing device 204 may identify a gift card number. In one embodiment, the identified gift card number may be a virtual controlled payment number. In step 708, the identified gift card number may be associated, in a database (e.g., the gift card database 112) with the merchant identifier and the gift amount such that payment transactions involving the identified gift card number are charged to the merchant account. In one embodiment, the processing device 204 may place a hold on the merchant account for the value of the gift amount.

In step 710, a transmitting device (e.g., the transmitting unit 206) may transmit the identified gift card number to the recipient 108. In one embodiment, transmitting the identified gift card number to the recipient 108 may include transmitting, by the transmitting device 206, the identified gift card number to a mobile communication device (e.g., the mobile device 110) associated with the recipient 108 for display in an application program configured as an electronic wallet. In another embodiment, transmitting the identified gift card number may include transmitting the identified gift card number to the mobile device 110 via a short message service (SMS) message.

In one embodiment, the method 700 may further include: receiving, by the receiving device 202, an authorization request for a payment transaction, wherein the authorization request includes at least the identified gift card number, the merchant identifier, and a transaction amount; processing, by the processing device 204, the financial transaction when the gift amount associated with the identified gift card number is at least equal to the transaction amount; and updating, in the database 112, the gift amount associated with the identified gift card number based on the transaction amount.

In a further embodiment, processing the financial transaction may include forwarding, by the transmitting device 206, the authorization request to a payment network, and receiving, by the receiving device 204, an authorization response from the payment network indicating approval of the payment transaction. In another further embodiment, the method 700 may further include transmitting, by the transmitting device 206, an authorization response indicating approval of the payment transaction in response to the received authorization request.

### Computer System Architecture

FIG. 8 illustrates a computer system 800 in which embodiments of the present disclosure, or portions thereof, may be implemented as computer-readable code. For example, the processing server 104 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 4, and 7.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device that is programmed in accordance with the process disclosed herein to be a specific purpose computer. The processor device 804 may be connected to a communication infrastructure 806, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive, the removable storage unit 818 may be a floppy disk. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

Data stored in the computer system 800 (e.g., in the main memory 808 and/or the secondary memory 810) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

Computer program medium and computer usable medium may refer to memories, such as the main memory 808 and secondary memory 810, which may be memory semiconductors (e.g. DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 3, 4, and 7, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

Techniques consistent with the present disclosure provide, among other features, systems and methods for processing gift card requests. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

1. A method for processing a gift card request, comprising:
receiving, by a receiving device, a gift card request for a gift card from a requesting device, wherein the gift card request includes at least a merchant identifier of a merchant, a gift amount, a payment account identifier, and a recipient;
processing, by a processing device, a payment transaction for the gift amount included in the gift card request from a payment account associated with the payment account identifier to a merchant account associated with the merchant identifier;
generating, by the processing device, a gift card number to be associated with the requested gift card;
storing, in a gift card database, the gift card number generated by the processing device with (i) the gift amount included in the gift card request and (ii) a merchant payment account associated with the merchant identifier included in the gift card request; and
transmitting, by a transmitting device, the generated gift card number to a mobile communication device of the recipient,
wherein when processing, by the processing device, future payment transactions involving the generated gift card number, the future payment transactions are funded by the merchant payment account stored, in the gift card database, in association with the generated gift card number.

2. The method of claim 1, further comprising:
receiving, by the receiving device, from the merchant, an authorization request for an attempted payment transaction, wherein the authorization request includes at least the generated gift card number, the merchant identifier, and a transaction amount;
processing, by the processing device, the attempted payment transaction when the gift amount associated with the generated gift card number is at least equal to the transaction amount; and
updating, in the database, the gift amount associated with the generated gift card number based on the transaction amount.

3. The method of claim 2, wherein processing the attempted payment transaction includes:
forwarding, by the transmitting device, the authorization request to a payment network, and
receiving, by the receiving device, an authorization response from the payment network indicating approval of the payment transaction.

4. The method of claim 2, further comprising:
transmitting, by the transmitting device, an authorization response to the merchant, wherein the authorization response indicates approval of the attempted payment transaction in response to the received authorization request.

5. The method of claim 1, wherein the recipient is at least one of: a phone number, an e-mail address, an account number, a username, and a consumer identifier.

6. The method of claim 1, wherein transmitting the generated gift card number to the recipient includes transmitting, by the transmitting device, the generated gift card number to a mobile communication device associated with the recipient for display in an application program configured as an electronic wallet.

7. The method of claim 1, wherein transmitting the generated gift card number to the recipient includes transmitting, by the transmitting device, the generated gift card number to a mobile communication device associated with the recipient via a short message service (SMS) message.

8. The method of claim 1, wherein the gift card request originates from a web page associated with the merchant identifier.

9. The method of claim 1, wherein the generated gift card number is a virtual controlled payment number.

10. The method of claim 1, wherein processing an attempted payment transaction for the gift amount includes transmitting, by the transmitting device, an authorization request to a payment network for the attempted payment transaction and receiving, by the receiving device, an authorization response indicating approval of the payment transaction.

11. The method of claim 1, further comprising:
placing a hold on the merchant account for the value of the gift amount.

12. A system for processing a gift card request, comprising:
a gift card database;
a receiving device configured to receive a gift card request for a gift card, from a requesting device, wherein the gift card request includes at least a merchant identifier, a gift amount, a payment account identifier, and a recipient;
a processing device configured to
process a payment transaction for the gift amount included in the gift card request from a payment account associated with the payment account identifier to a merchant account associated with the merchant identifier,
generating a gift card number to be associated with the requested gift card, and
store, in the gift card database, the gift card number generated by the processing device with (i) the gift amount included in the gift card request and (ii) a merchant payment account associated with the merchant identifier and the gift amount; and
a transmitting device configured to transmit the gift card number generated by the processor to a communication device of the recipient;
wherein when the processing device processes future payment transactions involving the generated gift card number, the future payment transactions are funded by the merchant payment account stored, in the gift card database, in association with the generated gift card number.

13. The system of claim 12, wherein
the receiving device is further configured to receive an authorization request from a merchant for an attempted payment transaction, wherein the authorization request includes at least the gift card number generated by the processing device, the merchant identifier, and a transaction amount, and
the processing device is further configured to
identify the attempted financial transaction when the gift amount associated with the generated gift card number is at least equal to the transaction amount, and
update, in the gift card database, the gift amount associated with the generated gift card number based on the transaction amount.

14. The system of claim 13, wherein processing the attempted financial transaction includes:
forwarding, by the transmitting device, the authorization request, received from the merchant, to a payment network, and
receiving, by the receiving device, an authorization response from the payment network indicating approval of the payment transaction.

15. The system of claim 13, wherein the transmitting device is further configured to transmit an authorization response to the merchant indicating approval of the payment transaction in response to the received authorization request.

16. The system of claim 12, wherein the recipient is at least one of: a phone number, an e-mail address, an account number, a username, and a consumer identifier.

17. The system of claim 12, wherein transmitting the generated gift card number to the recipient includes transmitting, by the transmitting device, the generated gift card number to a mobile communication device associated with the recipient for display in an application program configured as an electronic wallet.

18. The system of claim 12, wherein transmitting the generated gift card number to the recipient includes transmitting, by the transmitting device, the generated gift card number to a mobile communication device associated with the recipient via a short message service (SMS) message.

19. The system of claim 12, wherein the gift card request originates from a web page associated with the merchant identifier.

20. The system of claim 12, wherein the generated gift card number is a virtual controlled payment number.

21. The system of claim 12, wherein processing an attempted payment transaction for the gift amount includes transmitting, by the transmitting device, an authorization request to a payment network for the payment transaction and receiving, by the receiving device, an authorization response, from the payment network, indicating approval of the payment transaction.

22. The system of claim 12, wherein the processing device is further configured to place a hold on the merchant account for the value of the gift amount.

23. The method of claim 1, further comprising:
transmitting, by the transmitting device, a notification to a merchant associated with the merchant identifier included in the gift card request, said notification indicating the purchase of the gift card by said requester.

24. The system of claim 21, wherein the processing device is further configured to transmit a notification to the merchant associated with the merchant identifier included in the gift card request, said notification indicating the purchase of the gift card by said requester.
